(19) United States
(12) Patent Application Publication
(10) Pub. No.: US 2011/0063869 A1
(43) Pub. Date: Mar. 17, 2011

(54) Load safety marker light mounting device

(76) Inventor: Jamie T. Zoellner, Lancaster, SC (US)

(21) Appl. No.: 12/804,348

(22) Filed: Jul. 20, 2010

Related U.S. Application Data
(60) Provisional application No. 61/276,880, filed on Sep. 17, 2009.

(51) Int. Cl. B60Q 1/00; F21V 15/01

(52) U.S. Cl. 362/548; 362/368; 362/191

(57) ABSTRACT

A portable attachable and removable light mounting device comprising: a body, a light housing space, an access opening and cover, fasteners for securing the access cover, mounting points for mounting the device on a carrier, and a light enclosed within the body. A construction of commonplace materials used in the shipment of over-dimensional freight via commercial trucking to achieve compliance with safety lighting standards. The device comprises a main body having an interior space large enough to accommodate an emergency light, and a plurality of attachment points inset from each corner and midway along the long sides through which fasteners may be attached.

This application claims priority from provisional application Ser. No. 61/276,880 filed on 17 Sep. 2009, which application is incorporated herein in its entirety.

### FIELD OF THE INVENTION

The present invention is related to the field of safety lighting for vehicles, specifically a portable attachable/detachable safety lighting assembly adapted for use on vehicles of all shapes and sizes but particularly larger vehicles.

### BACKGROUND OF THE INVENTION

Although there exist both federal and state regulations specifying minimal standards for safety lighting on vehicles it is not uncommon to encounter vehicles that do not meet these standards. In many cases, the standards have been imposed after the vehicles are already in service.

Proper safety lighting is critically important for the protection of both the public and commercial vehicles in transit. It is particularly crucial for oversize vehicles like tractor-trailer truck assemblies. Such vehicles are highly vulnerable crossing intersections or making turns in dark places, exposing their sides to oncoming traffic. Sufficient lighting on such vehicles to make them easy to see provides protection against side-impact accidents that might otherwise occur. The present invention is intended to provide that protection and to make it portable from one vehicle to another, an important feature for operators who drive more than one type of vehicle.

### SUMMARY OF THE INVENTION

The present invention involves a construction of commonplace materials used in the shipment of over-dimensional freight via commercial trucking to achieve compliance with safety lighting standards. The invention comprises a main body that is a rectangular-shaped segment of heavy material having an interior space and secured along all sides to increase durability, having a distinct front and back side. The body comprises an interior space large enough to accommodate a battery powered emergency light, as well as a plurality of attachment points inset from each corner and midway along the long sides through which fasteners may be attached.

The exemplary embodiment of the invention comprises a protruding mesh light housing extending across an opening in the main body layer and forming the interior space in the body. The mesh is permanently secured to the main body layer on all sides. The mesh is of a dimension sufficient to hold said emergency light within. The mesh must also have a porosity sufficient enough to allow light to pass through, while also maintaining the strength, flexibility, resilience, and relative imperviousness to premature fatigue when exposed to the elements at extreme temperature, and in the presence of sunlight and environmental hazards.

The exemplary embodiment of the invention comprises an access flap extending across the opening in the main body layer secured to the main body layer on one side acting effectively as a hinge for the access flap. The opposite end is secured to the main body layer by a detachable fastener, such as Velcro™, or by snap fasteners or other conventional fastening systems. The safety light is inserted into the interior space and the entire apparatus affixed to the exterior of the vehicle to provide exterior safety lighting.

The device may be integrally formed with varying sized and shaped tarpaulin or other durable flexible material base to be more suited to more particular needs in circumstances not foreseen. In certain cases it might be advantageous for the light housing to be constructed of molded plastic, or for the light itself to be constructed in such a way as to accommodate or incorporate the tarpaulin body. Furthermore, materials can be substituted with other materials for more extreme weather and climate conditions.

### DESCRIPTION OF THE DRAWINGS

A detailed description of the embodiments of the present invention is provided herein below, by way of example only, with reference to the accompanying drawings, in which:

FIG. 1 is a plan view of the front side of the invention.

FIG. 2 is a side profile view of the left side showing the access flap on the back in its open position.

FIG. 3 is an orthographic profile view of the top side.

FIG. 4 is a plan view of the back (vehicle) side showing the access flap in a partially open position.

FIG. 5 is a side view of a vehicle showing an example of the invention attached.

### DETAILED DESCRIPTION

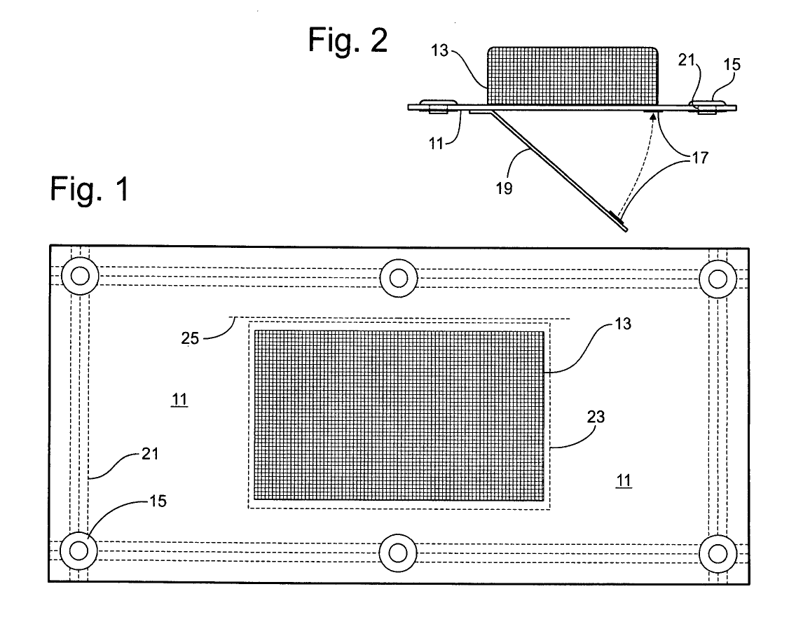

As shown in FIG. 1, an exemplary embodiment, the front (outward) face of the invention features the light housing (13), held to the tarpaulin fabric body (11) by light housing stitch (23) to facilitate an emergency (or visibility) light mounted centrally. Parallel along the outer edges of the tarpaulin fabric body (11), are the triple stitch grommet reinforcement (21), and at each corner as well as midway along each side are reinforced eyelets (15). The reinforced eyelets (15) are the mounting points for the invention and are disposed in such locations as to interrupt only the medial stitch of the triple stitch grommet reinforcement (21), and at each corner where triple stitch grommet reinforcement (21) intersect the reinforced eyelet (15), centered on the intersection of the medial stitch but not interrupting the outer stitches.

Shown in FIG. 2 is the side profile, again featuring the light housing (13) mounted centrally and displaying the protrusion of the light housing (13). Also displayed is a profile view of the tarpaulin fabric access flap (19) in its open position, as well as the hook-and-loop fasteners (17), used for securing the tarpaulin fabric access flap (19) to the tarpaulin fabric body (11), for the purpose of securing the emergency light in the light housing (13). The reinforced eyelets (15) and tarpaulin fabric body (11) are also seen in a profile view.

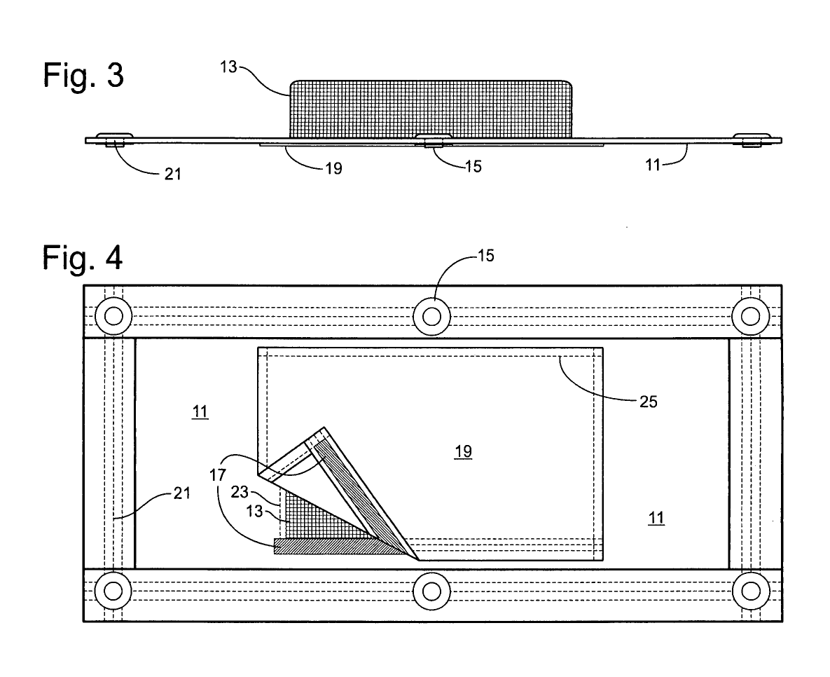

Shown in FIG. 3 is the top profile of the exemplary embodiment, again featuring the light housing (13) mounted centrally and displaying the protrusion of the light housing (13). The tarpaulin fabric access flap (19) is shown in its closed position. The tarpaulin fabric access flap (19) is held in place at one end by tarpaulin fabric access flap stitch (25) (FIGS. 1, 4) which acts effectively as its hinge. Reinforced eyelets (15) and tarpaulin fabric body (11) are also seen in the top profile view.

As shown in FIG. 4, the rear (vehicle side) face of the exemplary embodiment features the tarpaulin fabric access flap (19) in a partially open position, displaying the hook-and-loop fasteners (17), securing the tarpaulin fabric access flap (19) to the tarpaulin fabric body (11) for the purpose of enclosing the emergency light in the light housing (13). The tarpaulin fabric access flap (19) is held in place at one end by tarpaulin fabric access flap stitch (25) which acts effectively as its hinge. Parallel along the outer edges of the tarpaulin fabric body (11), the fabric is folded over on itself and secured by the triple stitch grommet reinforcement (21) and at each corner, as well as midway along each side by reinforced eyelets (15). The reinforced eyelets (15) are located in such locations as to interrupt only the medial stitch of the triple stitch grommet reinforcement (21), and at each corner where triple stitch grommet reinforcement (21) intersect the reinforced eyelet (15), centered on the intersection of the medial stitch, but not interrupting the outer stitches. Seen through the tarpaulin fabric access flap (19) is the interior side of the mesh fabric light housing (13).

### Operation

In the exemplary embodiment shown in the Figures, an emergency light is inserted into the light housing (13), by way of the operation of the access flap (19). The light is secured in position by the hook and loop fastener (17). The entire apparatus is secured to the load in the appropriate location as determined by state and/or federal law by the operator using rubber straps or Bungee™ cords or other suitable external fasteners using the reinforced eyelets (15) as mounting points.

The invention serves to meet several states' requirements for illumination of a trucking vehicle load, especially an oversize load. Previous methods are archaic and leave much room for improvement, and this device is intended to increase safety and efficiency for the driver of the vehicle, and all of those in the vicinity of his/her vehicle while in the loading process, and in transport.

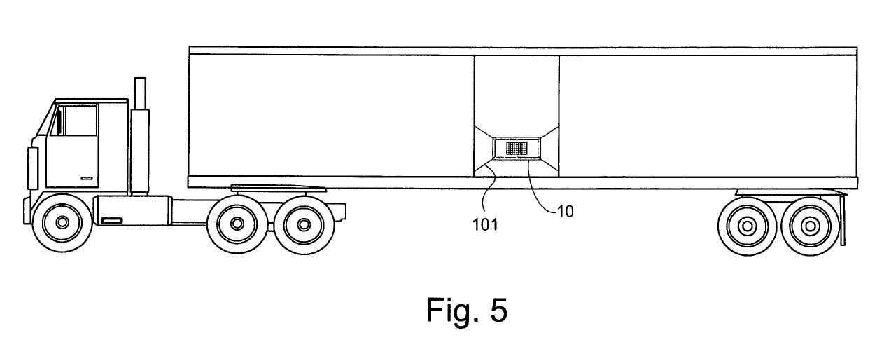

Reference to FIG. 5 illustrates the installation of the light mounting device on a vehicle. The light mounting device 10 is placed at a location on the vehicle that is not adequately protected by safety lights. Long length trailers, for example, may have lights on the tail but insufficient lighting on the sides, leaving those extended sides dark and dangerously exposed when the vehicle is making a turn or is crossing a road. As shown in FIG. 5, the light mounting device 10 is secured to the side of the vehicle by an appropriate means, such as elastic straps or rope 101 attached to the reinforced eyelets 15 provided on the body of the device 10.

While particular embodiments of the invention and its details have been implied, this invention can be manufactured in a variety of forms to suit a multitude of intended uses. Undoubtedly, numerous variations and modifications of the invention will become readily apparent to those familiar with articles of oversize freight safety equipment. Accordingly, the scope of the invention should not be construed as limited to the specific embodiment depicted and described, but rather, the reader should rightly view all the preceding embodiments as providing examples of the invention claimed. The scope of the invention should therefore be fixed by the stated claims, and not by the examples provided.

What is claimed is:

1. A portable attachable and removable light mounting device comprising: a body, a light housing space, an access opening and cover, fasteners for securing the access cover, mounting points for mounting the device on a carrier, and a light enclosed within the body.

2. The light mounting device of claim 1, wherein the body comprises a heavy-duty fabric.

3. The light mounting device of claim 2, wherein the light housing is a space formed within layers of the heavy-duty fabric.

4. The light mounting device of claim 3, wherein the access opening is covered by an access flap.

5. The light mounting device of claim 4, wherein the access flap is secured by fasteners.

6. The light mounting device of claim 5, wherein the fasteners comprise hook and loop fasteners.

7. The light mounting device of claim 3, wherein the light housing comprises a mesh material having sufficient porosity to permit light to shine through it.

8. The light mounting device of claim 3, wherein the light mounting device is secured to a carrier through eyelets on the device by one of elastic cords, rope, clips, hooks or wires.

9. A portable attachable and removable light mounting device for attachment to a vehicle comprising: a body, a light housing space, an access opening and cover, fasteners for securing the access cover, mounting points for mounting the device on a carrier, and a light enclosed within the light housing space in the body.

10. The vehicle light mounting device of claim 9 wherein the body of the device comprises at least first and second layers of heavy duty material stitched together.

11. The vehicle light mounting device of claim 9 wherein the light housing space comprises a mesh material with sufficient porosity to light to permit a light enclosed within the space to be seen at night.

12. The vehicle light mounting device of claim 9 wherein the access opening is covered by an access flap.

13. The vehicle light mounting device of claim 12, wherein the access flap is secured by fasteners.

14. The vehicle light mounting device of claim 9, wherein the mounting points on the device are eyelets fixed in the body of the device.

15. The vehicle light mounting device of claim 9, wherein the light mounting device is secured to a vehicle through eyelets on the device by one of elastic cords, rope, clips, hooks or wires.

16. The vehicle light mounting device of claim 9, wherein the light is battery powered.
